(19) United States
(12) Patent Application Publication
(10) Pub. No.: US 2020/0068058 A1
(43) Pub. Date: Feb. 27, 2020

(54) ELECTRONIC DEVICE AND METHOD FOR TURNING OFF DISPLAY

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: JUN-WEI ZHANG, Zhengzhou (CN); SEN FAN, Zhengzhou (CN)

(21) Appl. No.: 16/522,781

(22) Filed: Jul. 26, 2019

(30) Foreign Application Priority Data
Aug. 23, 2018 (CN) 201810968681.9

(51) Int. Cl. H04M 1/22

(52) U.S. Cl. CPC H04M 1/22; H04M 2250/12

(57) ABSTRACT

A method for turning off a display device in an electronic device controls a detecting device to detect various action parameters in a predetermined time period when a user is making or receiving a call by holding the device to his ear (to-ear call). A number of action parameters are set and several values for each parameter are established. Determining at least one action parameter having the number of values within a first predefined range to be a reference parameter and controlling the detecting device to detect the reference parameters of the electronic device for a to-ear call are provided. Determining whether each value of each reference parameter is within in a second predefined range and upon determining that a to-ear call is taking place, turning a display device off.

### CROSS-REFERENCE TO RELATED APPLICATIONS

This application claims priority to Chinese Patent Application No. 201810968681.9 filed on Aug. 23, 2018, the contents of which are incorporated by reference herein.

### FIELD

The subject matter herein generally relates to electronic device control technology, and particularly to an electronic device and a method for turning off a display.

### BACKGROUND

At least one infrared sensor is usually arranged on a smart phone, and is configured to detect whether a user is making a call by a handset of the smart phone, the smart phone can turn off the display screen when the infrared sensor detects that the user is making the call by the handset. However, when in use, the infrared sensor may be easily blocked by the user not intending to make a phone call, and the display screen may be turned off in error.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device.

FIG. 2 is a schematic diagram of an embodiment of area division of a display device of the electronic device.

FIG. 3 is a block diagram of an embodiment of a display turning off system.

FIG. 4 illustrates a flowchart of an embodiment of a method for turning off a display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

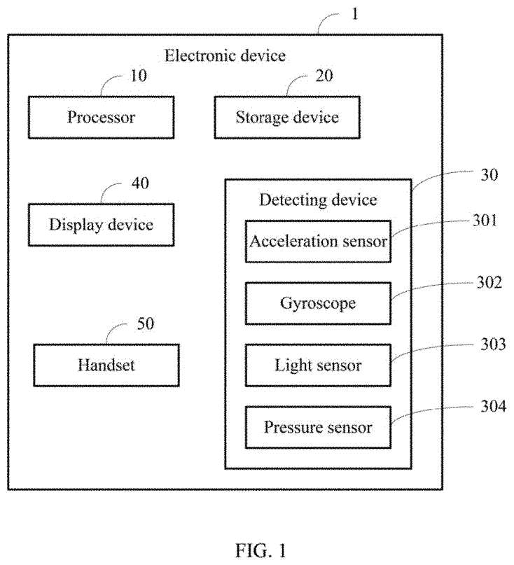

FIG. 1 illustrates an embodiment of an electronic device (electronic device 1). In at least one embodiment, the electronic device 1 can be a smart phone or other device with a communication function. The electronic device 1 can detect whether a handset of the electronic device 1 is used to make a call according to action habits of a user, and turn off a display device of the electronic device 1 when the handset is used to make the call, without configuring an infrared sensor.

The electronic device 1 includes, but is not limited to, a processor 10, a storage device 20, a detecting device 30, a display device 40, and a handset 50. FIG. 1 illustrates only one example of the electronic device 1, other examples can include more or fewer components than illustrated, or have a different configuration of the various components in other embodiments.

The processor 10 can be a central processing unit (CPU), a microprocessor, or other data processor chip that performs functions of the electronic device 1.

In at least one embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium.

In at least one embodiment, the detecting device 30 at least includes an acceleration sensor 301, a gyroscope 302, a light sensor 303, and a pressure sensor 304. The acceleration sensor 301 can detect an acceleration of the electronic device 1 when the user takes the electronic device 1 to one of his/her ears. The gyroscope 302 can detect an orientation or an inclination of the electronic device 1 when the user is making the call by the handset 50, the inclination can be an intersection angle between the electronic device 1 and a horizontal plane.

The light sensor 303 can detect a change of light intensity around the electronic device 1 when the user is making the call by the handset 50. The pressure sensor 304 can detect pressure applied on the display device 40 from the ear of the user, and determine an area of the display device 40 on which the ear is pressing by detecting the pressure from the ear of the user. In other embodiments, the pressure sensor 304 can detect pressure applied on the electronic device 1 from fingers of the user, and determine at least one area of the electronic device 1 on which the fingers are touching by detecting the pressure from the fingers of the user.

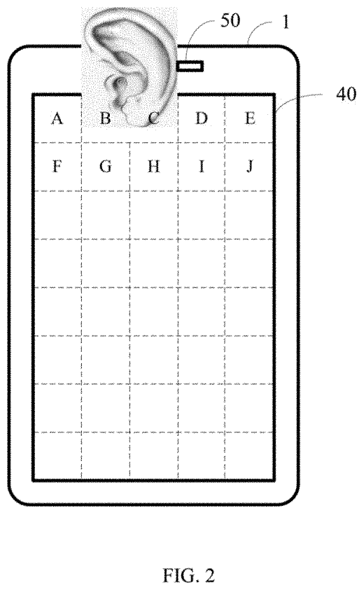

In at least one embodiment, the pressure sensor 304 is arranged under the display device 40. Referring to FIG. 2, the display device 40 is divided into a number of predefined areas. When the handset 50 is used to make the call, the pressure sensor 304 can determine at least one predefined area of the display device 40 which is pressed by the user's ear, according to pressure distribution. The at least one predefined area is the area of the display device 40 on which the user's ear is touching. For example, as illustrated in FIG. 2, the areas of the display device 40 on which the user's ear is touching include an area B and an area C.

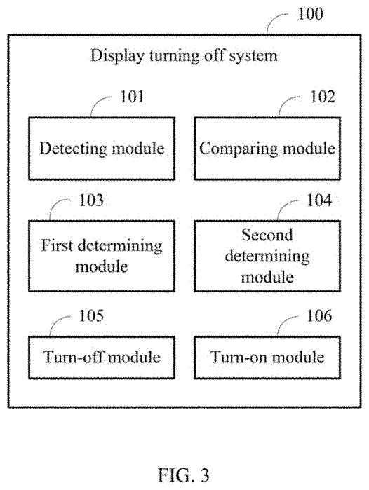

As illustrated in FIG. 3, the electronic device 1 runs a display turning off system 100. The display turning off system 100 at least includes a detecting module 101, a comparing module 102, a first determining module 103, a second determining module 104, a turn-off module 105, and a turn-on module 106. The modules 101-106 can be collections of software instructions stored in the storage device 20 of the electronic device 1 and executed by the processor 10. The modules 101-106 also can include functionality represented as hardware or integrated circuits, or as software and hardware combinations, such as a special-purpose processor or a general-purpose processor with special-purpose firmware.

The electronic device 1 can make determinations based on the action habits of the user when the handset 50 is used by machine memory and machine learning, and determine various action parameters which are used for determining whether the handset 50 is used to make the call. That is, when the user has performed an action of making the call using the handset 50, the detecting device 30 can detect the various action parameters of the electronic device 1, thus providing references for subsequently determining whether the handset 50 is used to make the call.

The detecting module 101 is used to control the detecting device 30 to detect action parameters of the electronic device 1 in a predetermined time period, when the handset 50 is used to make the call.

In at least one embodiment, making the call can include dialing the call and answering the call. The predetermined time period can be a month, the predetermined time period can be a period for machine learning of the electronic device 1. In the predetermined time period, every time that the electronic device 1 is on the call, the detecting module 101 can determine that the handset 50 is used to make the call, and control the detecting device 30 to detect the action parameters of the electronic device 1.

In at least one embodiment, the action parameters at least include an acceleration detected by the acceleration sensor 301, an inclination between the electronic device 1 and the horizontal plane detected by the gyroscope 302, a change value of the light intensity detected by the light sensor 303, a pressure applied on the display device 40 detected by the pressure sensor 304, and at least one area of the display device 40 on which the user's ear is touching.

The comparing module 102 is used to compare each value of each of the action parameters of the electronic device 1 with a first predefined range, and determine whether each value of each of the action parameters is within the first predefined range.

In at least one embodiment, every time that the handset 50 is used to make the call by the user, the detecting device 30 can detect a value of each action parameter of the electronic device 1, thus a number of values of each action parameter are acquired within the predetermined time period.

In at least one embodiment, multiple first predefined ranges are stored in the storage device 20, each action parameter corresponds to a first predefined range. For example, the first predefined range corresponding to the acceleration can be 3-5 m/s², the first predefined range corresponding to the inclination can be 60-120 degrees, the first predefined range corresponding to the change value of the light intensity can be 5000-6000 lux, the first predefined range corresponding to the pressure can be 0.5-1 N, and the first predefined range corresponding to the at least one touching area of the display device 40 can be the area B and the area C (shown in FIG. 2).

In at least one embodiment, when the values within the first predefined range are equal to or more than a predefined percent of the number of values of an action parameter, the comparing module 102 can determine that the number of values of the action parameter are within the first predefined range. In at least one embodiment, the predefined percent can be ninety-five percent.

The first determining module 103 is used to determine at least one action parameter having the number of values within the first predefined range to be a reference parameter.

In at least one embodiment, when one or two action parameters have the number of values within the first predefined range, the first determining module 103 determines the one or two action parameters to be the reference parameters. For example, a number of acceleration values detected by the acceleration sensor 301 include 4 m/s², 4.2 m/s², and 3.5 m/s². Apparently, the three acceleration values both are within the first predefined range 3-5 m/s², and the first determining module 103 can determine the acceleration parameter to be the reference parameter.

In at least one embodiment, when more than two action parameters have the number of values within the first predefined range, the first determining module 103 determines that two of the action parameters are the reference parameters, the number of values of the two action parameters have a smaller change range. In other embodiments, the first determining module 103 can also determine that any two of the action parameters can be the reference parameters. Types and quantity of the reference parameter are not limited to what is recited above.

When the first determining module 103 determines the reference parameters, the detecting module 101 controls the detecting device 30 to stop detecting the action parameters other than the reference parameters. For example, when the reference parameters include the acceleration parameter and the pressure parameter, the detecting module 101 controls the gyroscope 302 to stop detecting the inclination, and controls the light sensor 303 to stop detecting the change value of the light intensity.

The second determining module 104 is used to determine whether the electronic device 1 is used to receive a call in a handset mode or a hands-free mode, when the electronic device 1 receives the call.

In at least one embodiment, when the electronic device 1 receives the call, the display device 40 displays a call interface (not shown), and the call interface defines a hands-free option. When the hands-free option is activated by the user, the second determining module 104 determines that the electronic device 1 is used to receive the call in the hands-free mode. When the hands-free option is not activated, the second determining module 104 determines that the electronic device 1 is used to receive the call in the handset mode.

When the second determining module 104 determines that the electronic device 1 is used to receive the call in the handset mode, the detecting module 101 controls the detecting device 30 to detect the reference parameters of the electronic device 1.

In at least one embodiment, the reference parameters include the acceleration of the electronic device 1 and the pressure applied on the display device 40 from the user's ear. The detecting module 101 controls the acceleration sensor 301 to detect the acceleration of the electronic device 1, and controls the pressure sensor 304 to detect pressure applied on the display device 40 from the user's ear.

When determining that the electronic device 1 is used to receive the call in the hands-free mode, the second determining module 104 further determines whether a call mode of the electronic device 1 is switched from the hands-free mode to the handset mode. In at least one embodiment, if the hands-free option on the call interface is activated by the user when the electronic device 1 is used to make the call, the second determining module 104 determines that the call mode is switched form the hands-free mode to the handset mode.

When the second determining module 104 determines that the call mode is switched form the hands-free mode to the handset mode, the detecting module 101 controls the detecting device 30 to detect the reference parameters.

The second determining module 104 further determines whether each value of each of the reference parameters detected by the detecting device 30 is within in a second predefined range.

In at least one embodiment, the second predefined range is determined by the number of values of each reference parameter which is within the first predefined range. For example, the second predefined range can be a range which is smaller than a maximum value and greater than a minimum value of the number of values.

For example, a maximum value of the number of acceleration values is 4.2 m/s², and a minimum value of the number of acceleration values is 3.5 m/s². Thus the second predefined range corresponding to the acceleration parameter can be 3.5-4.2 m/s². A maximum value of the number of pressure values is 0.9 N, and a minimum value of the number of pressure values is 0.55 N. Thus the second predefined range corresponding to the pressure parameter can be 0.55-0.9 N.

When the second determining module 104 determines that each value of each of the reference parameters detected by the detecting device 30 is within in the second predefined range, the first determining module 103 further determines that the handset 50 is used to make the call.

When the first determining module 103 determines that the handset 50 is used to make the call, the turn-off module 105 is used to turn the display device 40 off.

The second determining module 104 further determines whether the call is ended by the electronic device 1.

In at least one embodiment, the electronic device 1 includes a button (not shown) for ending the call. When the button is pressed by the user, the second determining module 104 determines that the electronic device 1 is ending the call.

When the second determining module 104 determines that the electronic device 1 has ended the call, the turn-on module 106 is used to turn on the display device 40.

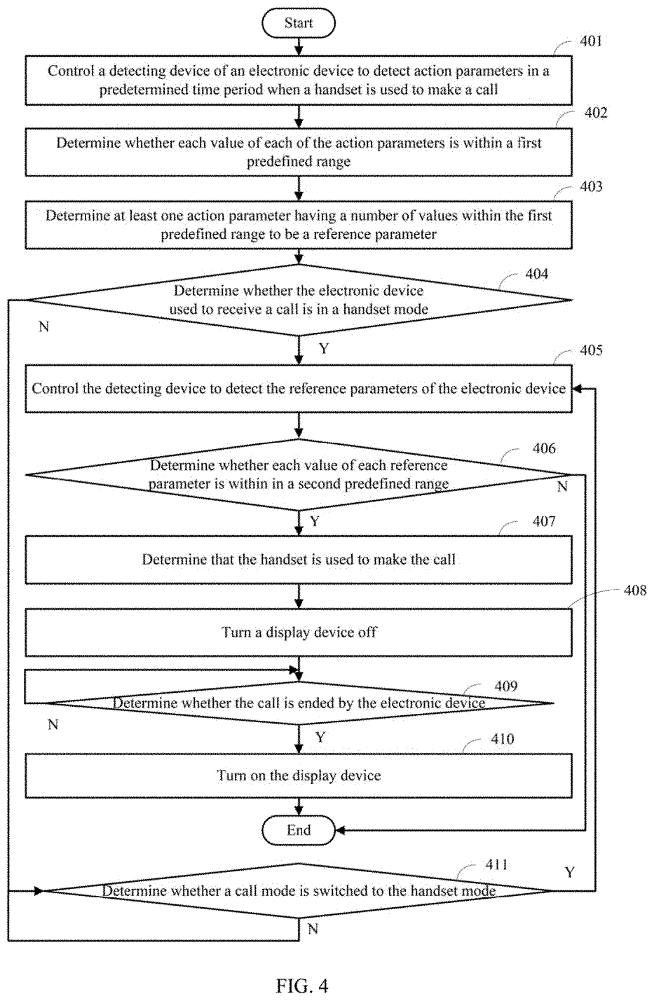

FIG. 4 illustrates a flowchart of an embodiment of a method for turning off a display device. The method is provided by way of example, as there are a variety of ways to carry out the method. The method described below can be carried out using the configurations illustrated in FIGS. 1 and 3, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 401.

At block 401, the detecting module 101 controls the detecting device 30 to detect action parameters of the electronic device 1 in a predetermined time period, when the handset 50 is used to make the call.

At block 402, the comparing module 102 determines whether each value of each of the action parameters is within the first predefined range.

At block 403, the first determining module 103 determines at least one action parameter having the number of values within the first predefined range to be a reference parameter.

At block 404, the second determining module 104 determines whether the electronic device 1 is used to receive a call in a handset mode or a hands-free mode, when the electronic device 1 receives the call. When the electronic device 1 is used to receive the call in the handset mode, the process goes to block 405. When the electronic device 1 is used to receive the call in the hands-free mode, the process goes to block 411.

At block 405, the detecting module 101 controls the detecting device 30 to detect the reference parameters of the electronic device 1.

At block 406, the second determining module 104 further determines whether each value of each of the reference parameters detected by the detecting device 30 is within in a second predefined range. When each value of each reference parameter detected by the detecting device 30 is within in the second predefined range, the process goes to block 407. When at least one value of the reference parameters detected by the detecting device 30 is not within in the second predefined range, the process ends.

At block 407, the first determining module 103 further determines that the handset 50 is used to make the call.

At block 408, the turn-off module 105 turns the display device 40 off.

At block 409, the second determining module 104 further determines whether the call is ended by the electronic device 1.

At block 410, the turn-on module 106 turns on the display device 40.

At block 411, the second determining module 104 further determines whether a call mode is switched from the hands-free mode to the handset mode. When the call mode is switched from the hands-free mode to the handset mode, the process goes to block 405. When the call mode is not switched from the hands-free mode to the handset mode, the process continues in block 411.

In at least one embodiment, the method further includes controlling the detecting device 30 to stop detecting the action parameters other than the reference parameter when the reference parameters are determined.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. An electronic device comprising:
at least one processor;
a detecting device coupled to the at least one processor;
a display device coupled to the at least one processor; and
a storage device coupled to the at least one processor and storing instructions for execution by the at least one processor to cause the at least one processor to:
control the detecting device to detect action parameters of the electronic device in a predetermined time period when a handset of the electronic device is used to make a call;
determine whether each value of each of the action parameters is within a first predefined range;
determine at least one of the action parameters having a plurality of values within the first predefined range to be a reference parameter;
control the detecting device to detect the reference parameters of the electronic device when the electronic device used to make the call is in a handset mode;
determine whether each value of each of the reference parameters detected by the detecting device is within in a second predefined range;
determine that the handset is used to make the call when determining that each value of each of the reference parameters detected by the detecting device is within in the second predefined range; and
turn the display device off when determining that the handset is used to make the call.

2. The electronic device according to claim 1, wherein the at least one processor is further caused to:
determine whether the electronic device is used to receive a call in the handset mode or a hands-free mode when the electronic device receives the call;
determine whether a call mode is switched from the hands-free mode to the handset mode when determining that the electronic device is used to receive the call in the hands-free mode; and
control the detecting device to detect the reference parameters of the electronic device when determining that the call mode is switched from the hands-free mode to the handset mode.

3. The electronic device according to claim 1, wherein the second predefined range is determined by the plurality of values of each of the reference parameters which are within the first predefined range, the second predefined range is a range which is smaller than a maximum value and greater than a minimum value of the plurality of values.

4. The electronic device according to claim 1, wherein the detecting device comprises an acceleration sensor, a gyroscope, a light sensor, and a pressure sensor, the acceleration sensor detects an acceleration of the electronic device when a user takes the electronic device to one of his/her ears, the gyroscope detects an orientation or an inclination of the electronic device when the handset is used to make the call, the light sensor detects a change of light intensity when the handset is used to make the call, the pressure sensor detects pressure applied on the display device from the ear of the user, and determines an area of the display device on which the ear is touching.

5. The electronic device according to claim 4, wherein the action parameters comprise an acceleration detected by the acceleration sensor, an inclination between the electronic device and the horizontal plane detected by the gyroscope, a change value of the light intensity detected by the light sensor, a pressure applied on the display device detected by the pressure sensor, and at least one area of the display device on which the ear of the user is touching.

6. The electronic device according to claim 1, wherein the at least one processor is further caused to:
determine whether the call is ended by the electronic device; and
turn on the display device when determining that the call is ended by the electronic device.

7. A method for turning off a display applicable in an electronic device comprising:
controlling a detecting device of the electronic device to detect action parameters of the electronic device in a predetermined time period when a handset of the electronic device is used to make a call;
determining whether each value of each of the action parameters is within a first predefined range;
determining at least one of the action parameters having a plurality of values within the first predefined range to be a reference parameter;
controlling the detecting device to detect the reference parameters of the electronic device when the electronic device used to make the call is in a handset mode;
determining whether each value of each of the reference parameters detected by the detecting device is within in a second predefined range;
determining that the handset is used to make the call when determining that each value of each of the reference parameters detected by the detecting device is within in the second predefined range; and
turning a display device of the electronic device off when determining that the handset is used to make the call.

8. The method according to claim 7, further comprising:
determining whether the electronic device is used to receive a call in the handset mode or a hands-free mode when the electronic device receives the call;
determining whether a call mode is switched from the hands-free mode to the handset mode when determining that the electronic device is used to receive the call in the hands-free mode; and
controlling the detecting device to detect the reference parameters of the electronic device when determining that the call mode is switched from the hands-free mode to the handset mode.

9. The method according to claim 7, wherein the second predefined range is determined by the plurality of values of each of the reference parameters which are within the first predefined range, the second predefined range is a range which is smaller than a maximum value and greater than a minimum value of the plurality of values.

10. The method according to claim 7, wherein the detecting device comprises an acceleration sensor, a gyroscope, a light sensor, and a pressure sensor, the acceleration sensor detects an acceleration of the electronic device when a user takes the electronic device to one of his/her ears, the gyroscope detects an orientation or an inclination of the electronic device when the handset is used to make the call, the light sensor detects a change of light intensity when the handset is used to make the call, the pressure sensor detects pressure applied on the display device from the ear of the user, and determines an area of the display device on which the ear is touching.

11. The method according to claim 10, wherein the action parameters comprise an acceleration detected by the acceleration sensor, an inclination between the electronic device and the horizontal plane detected by the gyroscope, a change value of the light intensity detected by the light sensor, a pressure applied on the display device detected by the pressure sensor, and at least one area of the display device on which the ear of the user is touching.

12. The method according to claim 7, further comprising:
determining whether the call is ended by the electronic device; and
turning on the display device when determining that the call is ended by the electronic device.

13. A non-transitory storage medium having instructions stored thereon, when the instructions are executed by a processor of an electronic device, the processor is configured to perform a method for turning off a display device, wherein the method comprises:
controlling a detecting device of the electronic device to detect action parameters of the electronic device in a predetermined time period when a handset of the electronic device is used to make a call;
determining whether each value of each of the action parameters is within a first predefined range;
determining at least one of the action parameters having a plurality of values within the first predefined range to be a reference parameter;
controlling the detecting device to detect the reference parameters of the electronic device when the electronic device used to make the call is in a handset mode;
determining whether each value of each of the reference parameters detected by the detecting device is within in a second predefined range;
determining that the handset is used to make the call when determining that each value of each of the reference parameters detected by the detecting device is within in the second predefined range; and
turning a display device of the electronic device off when determining that the handset is used to make the call.

14. The non-transitory storage medium according to claim 13, further comprising:
determining whether the electronic device is used to receive a call in the handset mode or a hands-free mode when the electronic device receives the call;
determining whether a call mode is switched from the hands-free mode to the handset mode when determining that the electronic device is used to receive the call in the hands-free mode; and
controlling the detecting device to detect the reference parameters of the electronic device when determining that the call mode is switched from the hands-free mode to the handset mode.

15. The non-transitory storage medium according to claim 13, wherein the second predefined range is determined by the plurality of values of each of the reference parameters which are within the first predefined range, the second predefined range is a range which is smaller than a maximum value and greater than a minimum value of the plurality of values.

16. The non-transitory storage medium according to claim 13, wherein the detecting device comprises an acceleration sensor, a gyroscope, a light sensor, and a pressure sensor, the acceleration sensor detects an acceleration of the electronic device when a user takes the electronic device to one of his/her ears, the gyroscope detects an orientation or an inclination of the electronic device when the handset is used to make the call, the light sensor detects a change of light intensity when the handset is used to make the call, the pressure sensor detects pressure applied on the display device from the ear of the user, and determines an area of the display device on which the ear is touching.

17. The non-transitory storage medium according to claim 16, wherein the action parameters comprise an acceleration detected by the acceleration sensor, an inclination between the electronic device and the horizontal plane detected by the gyroscope, a change value of the light intensity detected by the light sensor, a pressure applied on the display device detected by the pressure sensor, and at least one area of the display device on which the ear of the user is touching.

18. The non-transitory storage medium according to claim 13, further comprising:
determining whether the call is ended by the electronic device; and
turning on the display device when determining that the call is ended by the electronic device.
